(19) United States
(12) Patent Application Publication
(10) Pub. No.: US 2026/0336086 A1
(43) Pub. Date: Oct. 29, 2026

(54) Method for Operating a Piece of Working Equipment, and Piece of Working Equipment

(71) Applicant: Andreas Stihl AG & Co. KG, Waiblingen (DE)

(72) Inventors: Simon DIETRICH, Waiblingen (DE); Tim Daeweritz, Waiblingen (DE)

(21) Appl. No.: 19/659,547

(22) Filed: Apr. 27, 2026

(30) Foreign Application Priority Data
Apr. 28, 2025 (DE) 10 2025 116 320.0

(51) Int. Cl. B25F 5/00

(52) U.S. Cl. CPC B25F 5/001

(57) ABSTRACT

A method for operating a piece of working equipment, wherein the piece of working equipment has a drive motor having an output shaft, and a tool coupled to the output shaft, includes the following steps: forming at least two torque-angular acceleration pairs wherein a respective torque-angular acceleration pair comprises a torque generated by the drive motor and a corresponding angular acceleration, determining a moment of inertia of the tool as a function of the formed at least two torque-angular acceleration pairs, and operating the working equipment on the basis of the determined moment of inertia of the tool.

### CROSS REFERENCE TO RELATED APPLICATION

This application claims priority under 35 U.S.C. § 119 from German Patent Application No. 10 2025 116 320.0, filed Apr. 28, 2025, the entire disclosure of which is herein expressly incorporated by reference.

### BACKGROUND AND SUMMARY

The invention addresses the problem of providing a method for operating a piece of working equipment and for providing a piece of working equipment which make it possible to determine the moment of inertia of a tool of the working equipment as reliably as possible, particularly even when the tool is in contact with a workpiece being machined.

The method is used to operate a piece of working equipment, wherein the piece of working equipment comprises a drive motor with an output shaft and a tool coupled to the output shaft.

The method includes the steps of: forming at least two torque-angular acceleration pairs, wherein each torque-angular acceleration pair comprises a torque generated by the drive motor and a corresponding angular acceleration, determining a moment of inertia of the tool based on the at least two torque-angular acceleration pairs formed, and operating the working equipment based on the determined moment of inertia of the tool. The respective torques and angular accelerations of the at least two torque-angular acceleration pairs are non-zero.

In one embodiment, to form the at least two torque-angular acceleration pairs, at least two different torques are specified and the resulting angular accelerations are measured.

In one embodiment, to form the at least two torque-angular acceleration pairs, at least two different angular acceleration are specified and the resulting angular torques are measured.

In one embodiment, the method includes the following steps: applying a first torque to the output shaft via the drive motor in such a way as to produce a first angular acceleration of the output shaft that is non-zero, and in particular positive, and measuring the first angular acceleration of the output shaft resulting from the first torque, subsequently applying a second torque, different from the first torque, to the output shaft via the drive motor in such a way that a second angular acceleration of the output shaft, different from zero and from the first angular acceleration, and in particular positive, results, measuring the second angular acceleration of the output shaft resulting from the second torque, and determining the moment of inertia of the tool as a function of the first torque, the second torque, the first angular acceleration and the second angular acceleration.

In one embodiment, the operation of the working tool, depending on the determined moment of inertia, comprises at least one of the following steps: setting a maximum speed for the output shaft based on the determined moment of inertia, and enabling or disabling device functions based on the determined moment of inertia.

In one embodiment, the first torque and the second torque are selected such that the first angular acceleration and the second angular acceleration have the same sign. Alternatively, the first torque and the second torque are selected such that the first angular acceleration and the second angular acceleration have different signs.

The working equipment according to the invention comprises: a drive motor with an output shaft, a tool coupled to the output shaft, in particular for conjoint rotation, and a control unit which controls the operation of the working equipment in such a way that the method described above is carried out.

For example, the tool may be coupled to the output shaft directly or via a rigid connection, or it may be coupled to the output shaft via a belt, a transmission, etc.

The tool could be, for example, a cutting disk, a circular chain, a lawnmower blade, etc.

The working equipment in question could be, for example, an angle grinder, a chainsaw, a lawnmower, etc.

In one embodiment, the drive motor is an electric motor.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a highly schematic block diagram of a piece of working equipment according to an embodiment of the invention; and

FIG. 2 shows an example of a speed curve over time for determining the moment of inertia of a tool belonging to the working device shown in FIG. 1, in two different versions.

### DETAILED DESCRIPTION OF THE DRAWINGS

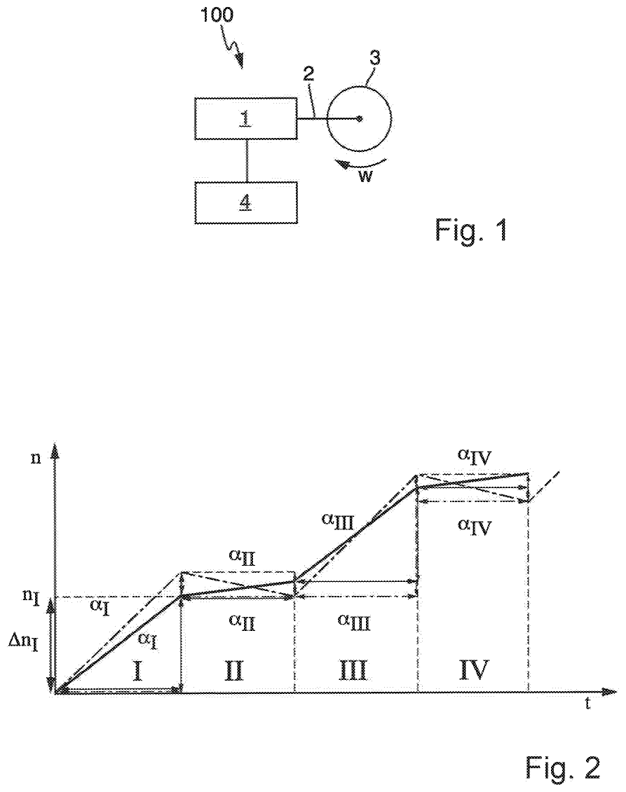

FIG. 1 shows a highly schematic block diagram of a piece of working equipment 100 exemplified by an angle grinder comprising a drive motor 1 in the form of an electric motor with an output shaft 2, a tool 3 in the form of a cutting disk, coupled to the output shaft 2 via a belt (not shown), and a control unit 4 in the form of a microprocessor controller, which controls the operation of the working equipment 100 in such a way that a method described below is carried out.

According to the invention, at least two torque-angular acceleration pairs M_{I}, α_{I} and M_{II}, α_{II} are formed, wherein a respective torque-angular acceleration pair M_{I}, α_{I} and M_{II}, an comprises a torque M_{I} or M_{II} generated by the drive motor 1 and a corresponding angular acceleration α_{I} or a_{II} respectively. The moment of inertia I of the tool 3 is determined based on the formed at least two torque-angular acceleration pairs M_{I}, α_{I} and M_{II}, α_{II}. The working equipment 100 is operated on the basis of the determined moment of inertia I of the tool 3.

The respective torques and angular accelerations of the at least two torque-angular acceleration pairs are non-zero, i.e., the following applies: M_{I}≠0, α_{I}≠0, M_{II}≠0, an α_{II}≠0. The following also applies: M_{I}≠M_{II}, α_{I}≠α_{II}, in order to obtain a sufficient number of independent equations for calculating the moment of inertia.

FIG. 2 shows an example of the speed curve over time used to determine the moment of inertia I of the tool 100 in two different variants.

During a first time interval I, the first torque M_{I} is applied to the output shaft 2 by the drive motor 1, resulting in the first angular acceleration ai. The first torques M_{I} of the alternatives shown differ in value but have the same sign.

During a second, subsequent time interval II, the second torque Mn is applied to the output shaft 2 by the drive motor 1, resulting in the second angular acceleration an. In one of the variants shown, the second angular acceleration α_{II} is positive; in the other variant shown, it is negative.

Optionally, time intervals III and IV, and possibly further time intervals, may follow, with the first torque M_{I} being applied again in time interval III and the second torque M_{II} being applied again in time interval IV. The following applies: α_{I}=α_{III}≠α_{II}=α_{IV}.

The moment of inertia I of the tool 3 is calculated as follows, depending on the first torque M_{I}, the second torque M_{II}, the first angular acceleration α_{I} and the second angular acceleration α_{II}:

$$K = \frac{( 2 * Δ {n}_{I} * {n}_{p} ) - {n}_{m ax}}{{n}_{m ax}}$$

$${I}_{ges} = \frac{{M}_{I} - {M}_{II}}{{α}_{I} + {α}_{II}}$$

$$I = {I}_{ges} * \frac{1}{K} .$$

Here, K is a correction factor determined partly by calculation and partly empirically; nₚ is the number of torque-angular acceleration pairs; nₘₐₓ is the maximum speed of the working machine; Δn_{I} is the speed difference in the first section I; and I_{ges} is an intermediate quantity in the form of total mass inertia. This intermediate value still reflects the effective friction of the workpiece and is then converted to the moment of inertia I of the tool using the correction factor K.

According to the invention, any contact between the tool and a workpiece can be compensated for when determining the moment of inertia of the tool. Even without the tool coming into contact with the workpiece, the invention naturally provides reliable values for the moment of inertia of the tool. If the tool is in contact with the workpiece, the ‘braking’ effect of the workpiece is factored out using the above formulas. This is based on the ratios of the required motor torques, the desired difference in the specified speeds, and the resulting angular accelerations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a piece of working equipment having a drive motor with an output shaft, and a tool coupled to the output shaft,
the method comprising the steps of:
forming at least two torque-angular acceleration pairs (MI, αI; MII, αII), wherein a respective torque-angular acceleration pair (MI, αI; MII, αII) comprises a torque (MI; MII) generated by the drive motor and a corresponding angular acceleration (αI; αII);
determining a moment of inertia (I) of the tool as a function of the formed at least two torque-angular acceleration pairs (MI, αI; MII, αII); and
operating the working equipment on the basis of the determined moment of inertia (I) of the tool.

2. The method as claimed in claim 1, wherein
to form the at least two torque-angular acceleration pairs (MI, αI; MII, αII), at least two different torques (MI; MII) are specified and the resulting angular accelerations (αI; αII) are measured.

3. The method as claimed in claim 1, wherein
to form the at least two torque-angular acceleration pairs (MI, αI; MII, αII), at least two different angular accelerations (αI; αII) are specified and the resulting torques (MI; MII) are measured.

4. The method as claimed in claim 1, wherein to form the at least two torque-angular acceleration pairs (MI, αI; MII, αII), the method further comprises the steps of:
applying a first torque (MI) to the output shaft via the drive motor such that a first angular acceleration (αI) of the output shaft is produced which is non-zero, and measuring the first angular acceleration (αI) of the output shaft resulting from the first torque (MI); and
immediately thereafter, applying a second torque (MII) to the output shaft via the drive motor, which second torque differs from the first torque (MI), such that a second angular acceleration (αII) of the output shaft, which is different from the first angular acceleration (αI), is produced, and measuring the second angular acceleration (αII) of the output shaft resulting from the second torque (MII);
wherein the moment of inertia (I) of the tool is determined as a function of the first torque (MI), the second torque (MII), the first angular acceleration (αI) and the second angular acceleration (αII).

5. The method as claimed in claim 1, wherein the operation of the working tool in accordance with the determined moment of inertia (I) comprises at least one of the steps of:
setting a maximum speed for the output shaft based on the determined moment of inertia (I); and
enabling or disabling device functions depending on the determined moment of inertia (I).

6. The method as claimed in claim 4, wherein
the first moment of inertia (MI) and the second moment of inertia (MII) are chosen such that the first angular acceleration (αI) and the second angular acceleration (αII) have the same sign.

7. The method as claimed in claim 4, wherein
the first torque (MI) and the second torque (MII) are chosen such that the first angular acceleration (αI) and the second angular acceleration (aII) have different signs.

8. A piece of working equipment, comprising:
a drive motor having an output shaft;
a tool coupled to the output shaft; and
a control unit that controls operation of the working equipment, the control unit being configured so as to:
form at least two torque-angular acceleration pairs (MI, αI; MII, αII), wherein a respective torque-angular acceleration pair (MI, αI; MII, αII) comprises a torque (MI; MII) generated by the drive motor and a corresponding angular acceleration (αI; aII);
determine a moment of inertia (I) of the tool as a function of the formed at least two torque-angular acceleration pairs (MI, αI; MII, αII); and
operate the working equipment on the basis of the determined moment of inertia (I) of the tool.

9. The piece of working equipment as claimed in claim 8, wherein the drive motor is an electric motor.

10. The piece of working equipment as claimed in claim 8, wherein the working equipment is a cutting disk.
